(19) United States
(12) Patent Application Publication
(10) Pub. No.: US 2007/0114951 A1
(43) Pub. Date: May 24, 2007

(54) DRIVE CIRCUIT FOR A LIGHT EMITTING DIODE ARRAY

(76) Inventors: Chia-Hung Tsen, Hsinchu County (TW); Feng-Rurng Juang, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 11/164,409

(22) Filed: Nov. 22, 2005

(51) Int. Cl. H05B 41/36

(52) U.S. Cl. 315/291

(57) ABSTRACT

A voltage regulator supplies a drive voltage to a light emitting diode array. A current regulator has a plurality of current regulating terminals, correspondingly coupled to a plurality of constituting branches of the light emitting diode array, for controlling a plurality of drive currents respectively flowing through the plurality of constituting branches. An activation circuit causes the drive voltage to continuously rise until each of voltages at the current regulating terminals exceeds a reference voltage, thereby ensuring that each of the plurality of drive currents reaches a regulation current. Afterwards, a selection circuit selects a minimum voltage from all of the voltages at the current regulating terminals to serve as a feedback control signal for controlling the voltage regulator.

### BACKGROUND OF THE INVENTION

1. Field of the Invention

The present invention relates to a drive circuit and, more particularly, to a drive circuit for a light emitting diode (LED) array.

2. Description of the Related Art

In the application where a large area of lighting source is desirable or necessary, such as the back light of a liquid crystal display, an LED array formed by a plurality of parallel-coupled LED constituting branches is considered a power-saving as well as space-saving solution to the generation of light. To achieve a homogeneous brightness all over the surface of the LED array, each constituting branch must be driven with an identical drive current since the brightness of the LED directly depends on the drive current flowing through it.

FIG. 1 is a circuit diagram showing a conventional drive circuit 10, for driving an LED array 11. The conventional drive circuit 10 mainly has a voltage regulator 12 and a current regulator 13. The voltage regulator 12 is used for converting an input voltage Vᵢₙ into a drive voltage Vₒᵤₜ to be supplied to the LED array 11. The LED array 11 is formed by a plurality of constituting branches D₁ to Dₙ which are coupled together in parallel. The current regulator 13 has a plurality of current regulating terminals A₁ to Aₙ, correspondingly coupled to n-type electrodes (cathodes) of the constituting branches D₁ to Dₙ of the LED array 11, for maintaining the identical drive currents I₁ to Iₙ to respectively flow through the constituting branches D₁ to Dₙ and therefore achieving a homogeneous brightness all over the LED array 11.

Referring to FIG. 2, the conventional current regulator 13 may be formed by a plurality of linear regulating units LR₁ to LRₙ for individually controlling the drive currents I₁ to Iₙ in an independent way. Hereinafter is described in detail the configuration and operation of the linear regulating unit LR₁ as an example. First of all, the current regulating terminal A₁ is coupled to a ground potential through a current path of a transistor Q₁ and a resistor R. An output signal of an error amplifier EA₁ is applied to the gate electrode of the transistor Q₁ and therefore adjust the drain-source current path resistance of the transistor Q₁. Through the error amplifier EA₁, the potential difference across the resistor R is maintained as equal to a reference voltage Vᵢᵣ. Since the drive current I₁ flows through the resistor R, the drive current I₁ is effectively regulated into a predetermined regulation current of (Vᵢᵣ/R) in compliance with the Ohm's law. Likewise, each of the other linear regulating units LR₂ to LRₙ causes the corresponding one of the drive currents I₂ to Iₙ to be regulated into the regulation current of (Vᵢᵣ/R).

Referring back to FIG. 1, even under the condition that the drive currents I₁ to Iₙ flowing through constituting branches D₁ to Dₙ are maintained identical, the forward voltage drop across each of the constituting branches D₁ to Dₙ is slightly different with respect to one another because the unavoidable finite tolerance range during manufacturing processes prevents any two LEDs from having the exactly same physical and electrical parameters. In other words, since the p-type electrodes (anodes) of the LED array 11 are coupled together to the drive voltage Vₒᵤₜ, the different forward voltage drops produce the different voltages V₁ to Vₙ at the current regulating terminals A₁ to Aₙ of the current regulator 13. In this situation, if there is only one current regulating terminal that is detected, for example the current regulating terminal A₁ shown in FIG. 1, in order to provide a feedback signal to the error amplifier 14, which generates an error signal Vₑᵣᵣ in response to the difference between the current regulating terminal voltage V₁ and the reference voltage V_{ref} so as to control the voltage regulator 12 for supplying an appropriate drive voltage Vₒᵤₜ. However, such drive voltage Vₒᵤₜ generated in accordance with the feedback of the voltage V₁ can only make sure that the linear regulating unit LR₁ is supplied with a voltage enough for regulating the drive current I₁ into the desired regulation current of (Vᵢᵣ/R). Unfortunately at this time, some of the other voltages V₂ to Vₙ at the current regulating terminals A₁ to Aₙ are possibly falling lower than the actually detected voltage V₁, resulting in incompetence to regulating the drive currents I₂ to Iₙ. Therefore, it is desirable to provide a drive circuit capable of supplying a drive voltage enough for ensuring that all of the linear regulating units LR₁ to LRₙ are effectively operated to regulate the drive currents I₁ to Iₙ.

### SUMMARY OF THE INVENTION

An object of the present invention is to provide a drive circuit for driving an LED array such that each constituting branch generates an identical brightness. Also, the drive circuit according to the present invention supplies a drive voltage enough for allowing all of the current regulating units to effectively regulate drive currents even though each of the constituting branches has different physical and electrical parameters.

According to one aspect of the present invention, a drive circuit is provided for driving a light emitting diode array formed by a plurality of constituting branches. The drive circuit includes a voltage regulator, a current regulator, an activation circuit, and a selection circuit. The voltage regulator supplies a drive voltage to the light emitting diode array. The current regulator has a plurality of current regulating terminals, correspondingly coupled to the plurality of constituting branches, for respectively controlling a plurality of drive currents flowing though the plurality of constituting branches. The activation circuit applies an activation control signal to the voltage regulator such that the drive voltage is being raised until each of voltages at the plurality of current regulating terminals exceeds a first reference voltage. Thereby, each of the plurality of drive currents reaches a predetermined regulation current. Afterwards, the selection circuit selects a minimum voltage from the voltages at the plurality of current regulating terminals to serve as a feedback control signal for controlling the voltage regulator.

According to another aspect of the present invention, a drive circuit is provided for driving a light emitting diode array formed by a plurality of constituting branches. The drive circuit includes a voltage regulator, a current regulator, an activation circuit, a detection circuit, and a selection circuit. The voltage regulator supplies a drive voltage to the light emitting diode array. The current regulator has a plurality of current regulating terminals, correspondingly coupled to the plurality of constituting branches, for respectively controlling a plurality of drive currents flowing through the plurality of constituting branches. The activation circuit applies an activation control signal to the voltage regulator such that the drive voltage is being raised until each of voltages at the plurality of current regulating terminals exceeds a first reference voltage. The detection circuit detects the voltages at the plurality of current regulating terminals, one voltage at a time, and for generating a detection signal. The selection circuit compares the detection signal and a second reference voltage, and allows the detection signal to be output as a feedback control signal for controlling the voltage regulator when the detection signal is lower than the second reference voltage.

According to still another aspect of the present invention, a drive method is provided for driving a plurality of light emitting diode branches, each of which has a first electrode and a second electrode. First of all, a drive voltage is supplied to the first electrodes of the plurality of light emitting diode branches. A plurality of drive currents is controlled to flow through the plurality of light emitting diode branches, respectively by the second electrodes of the plurality of light emitting diode branches. The drive voltage is being raised until each of voltages at the second electrodes of the plurality of light emitting diode branches exceeds a first reference voltage. Thereby, each of the plurality of drive currents flowing through the plurality of light emitting diode branches reaches a predetermined regulation current. From the voltages at the second electrodes of the plurality of light emitting diode branches, a minimum voltage is selected to serve as a feedback control signal. The drive voltage is then controlled based on the feedback control signal.

### BRIEF DESCRIPTION OF THE DRAWINGS

The above-mentioned and other objects, features, and advantages of the present invention will become apparent with reference to the following descriptions and accompanying drawings, wherein:

FIG. 1 is a circuit diagram showing a conventional drive circuit;

FIG. 2 is a detailed circuit diagram showing a conventional current regulator;

FIG. 3 is a circuit block diagram showing a drive circuit according to a first embodiment of the present invention;

FIG. 4 is a detailed circuit diagram showing an over-voltage activation circuit according to a first embodiment of the present invention;

FIG. 5 is a detailed circuit diagram showing a feedback selection circuit according to a first embodiment of the present invention; and

FIG. 6 is a circuit block diagram showing a drive circuit according to a second embodiment of the present invention;

FIG. 7 is a waveform timing chart showing clock signals according to a second embodiment of the present invention;

FIG. 8 is a detailed circuit diagram showing a discrete detection circuit according to a second embodiment of the present invention; and

FIG. 9 is a detailed circuit diagram showing an over-voltage activation circuit and a feedback selection circuit according to a second embodiment of the present invention.

### DETAILED DESCRIPTION OF THE PREFERRED EMBODIMENTS

The preferred embodiments according to the present invention will be described in detail with reference to the drawings.

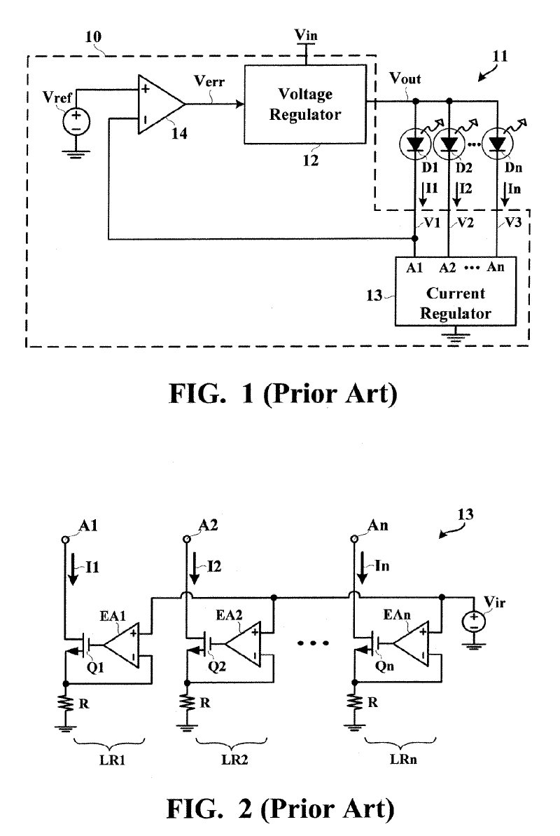

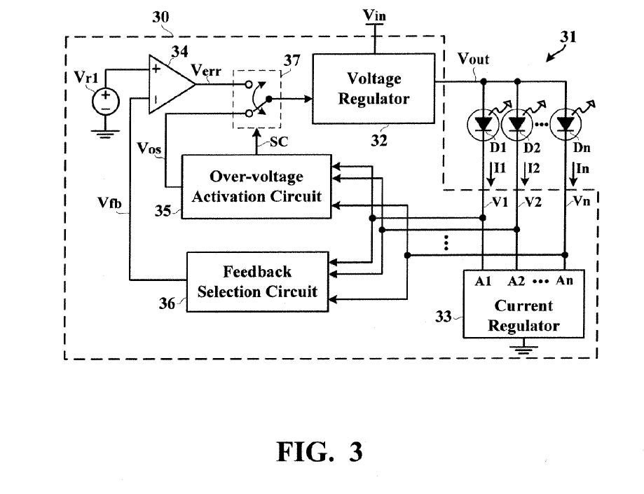

FIG. 3 shows a drive circuit 30 according to a first embodiment of the present invention, for driving an LED array 31. The drive circuit 30 of the first embodiment primarily includes a voltage regulator 32, a current regulator 33, an error amplifier 34, an over-voltage activation circuit 35, a feedback selection circuit 36, and a switching circuit 37. The voltage regulator 32 is used for converting an input voltage source Vᵢₙ into a drive voltage Vₒᵤₜ to be supplied to p-type electrodes (anodes) of the LED array 31. The input voltage source Vᵢₙ may be implemented by any type of DC voltage sources, such as a battery, a DC voltage output from other voltage regulators, and the like. The voltage regulator 32 may be implemented by any type of voltage regulators, such as buck, boost, buck-boost, pulse-width-modulation, pulse-frequency-modulation switching converter, low-drop-out (LDO) linear converter, or capacitive charge pump. The configuration and operation of the voltage regulator 32 are well-known to one skilled in the art and therefore will not be described hereinafter. The LED array 31 is formed by a plurality of constituting branches D₁ to Dₙ which are coupled together in parallel. It should be noted that although in FIG. 3 each of the constituting branches D₁ to Dₙ is shown to have only one LED inside as a representative, each of the constituting branches D₁ to Dₙ may include a plurality of series-connected LEDs without limitations. The current regulator 33 has a plurality of current regulating terminals A₁ to Aₙ, correspondingly coupled to n-type electrodes (cathodes) of the constituting branches D₁ to Dₙ of the LED array 31, for maintaining the identical drive currents I₁ to Iₙ to respectively flow through the constituting branches D₁ to Dₙ and therefore achieving a homogeneous brightness all over the LED array 31. The current regulator 33 may be implemented by a conventional current regulator 13 shown in FIG. 2, which is formed by a plurality of linear regulating units LR₁ to LRₙ. Therefore, each of the drive currents I₁ to Iₙ is regulated into a predetermined regulation current of (Vᵢᵣ/R) by the linear regulating units LR₁ to LRₙ of the current regulator 33.

In order to achieve a homogeneous brightness all over the LED array 31, the drive circuit 30 according to the first embodiment of the present invention is operated in two phases: the first phase is referred to as “over-voltage activation phase” and the second phase is referred to as “feedback selection phase.” More specifically, as soon as the drive circuit 30 is powered on for operation, such as when the input voltage source Vᵢₙ is raised over an appropriate level and applied to the drive circuit 30, the over-voltage activation circuit 35 generates an activation control circuit Vₒₛ, which is applied to the voltage regulator 32 through the switching circuit 37. The activation control signal Vₒₛ is used for controlling the voltage regulator 32 and determining the drive voltage Vₒᵤₜ during the initial, activating period of operation. For example, in the case where the voltage regulator is implemented by a switching converter, the activation control signal Vₒₛ is used for controlling the duty cycle of the switching power transistor, thereby determining the drive voltage Vₒᵤₜ. In another case where the voltage regulator 32 is implemented by a capacitive capacitor, the activation control signal Vₒₛ is used for controlling the charge current applied to the pumping capacitor, thereby determining the drive voltage Vₒᵤₜ. In order to ensure that the current regulating terminal voltages V₁ to Vₙ are sufficient to allow all of the linear regulating units LR₁ to LRₙ of the current regulator 33 to regulate the drive currents I₁ to Iₙ into the predetermined regulation current (Vᵢᵣ/R), the activation control signal Vₒₛ during the over-voltage activation phase continuously raises up the drive voltage Vₒᵤₜ of the voltage regulator 32 until all of the current regulating terminal voltages V₁ to Vₙ exceed a predetermined second reference voltage Vᵣ₂. Such second reference voltage Vᵣ₂ is predetermined in consideration of the desirable drive currents I₁ to Iₙ and the parameters of the elements in the current regulator 33, and the second reference voltage Vᵣ₂ must be set larger than the minimum possible voltage at which each of the linear regulating units LR₁ to LRₙ is able to operate normally and correctly. As a result after the over-voltage activation phase is finished, all of the linear regulating units LR₁ to LRₙ are able to regulate the drive currents I₁ to Iₙ into the predetermined regulation current of (Vᵢᵣ/R). A homogeneous brightness is obtained all over the LED array 31.

Once the over-voltage activation phase is finished, the over-voltage activation circuit 35 generates a switching control signal SC for causing the switching circuit 37 to couple the output terminal of the error amplifier 34 to the voltage regulator 32 and stop delivering the activation control signal Vₒₛ. In other words, the operation of the drive circuit 30 enters the feedback selection phase, during which the drive voltage Vₒᵤₜ of the voltage regulator 32 is determined by the feedback selection circuit 36 instead of the activation control signal Vₒₛ. The feedback selection circuit 36 is used for selecting a minimum voltage from the current regulating terminal voltages V₁ to Vₙ to serve as a feedback control signal V_{fb}. Based on the comparison between the feedback control signal V_{fb} and a first reference voltage Vᵣ₁, the error amplifier 34 generates an error signal Vₑᵣᵣ. The error signal Vₑᵣᵣ is applied to the voltage regulator 32 through the switching circuit 37 such that the output voltage Vₒᵤₜ is regulated to maintain the feedback selection signal V_{fb} substantially equal to the first reference voltage Vᵣ₁. Because the feedback control signal V_{fb} is selected from the minimum voltage of the current regulating terminal voltages V₁ to Vₙ, maintaining the feedback selection signal V_{fb} substantially equal to the first reference voltage Vᵣ₁ makes sure that each of the current regulating terminal voltages V₁ to Vₙ is kept not lower than the first reference voltage Vᵣ₁. During the feedback selection phase, all of the linear regulating units LR₁ to LRₙ of the current regulator 33 is able to regulate the drive currents I₁ to Iₙ into the predetermined regulation current of (Vᵢᵣ/R) since the first reference voltage Vᵣ₁ is set higher than the minimum possible voltage at which all of the linear regulating units LR₁ to LRₙ are allowed to operate normally and correctly. It should be noted that in the second embodiment, the first and second reference voltages Vᵣ₁ and Vᵣ₂ satisfy the following relationship: Vᵣ₁≦Vᵣ₂.

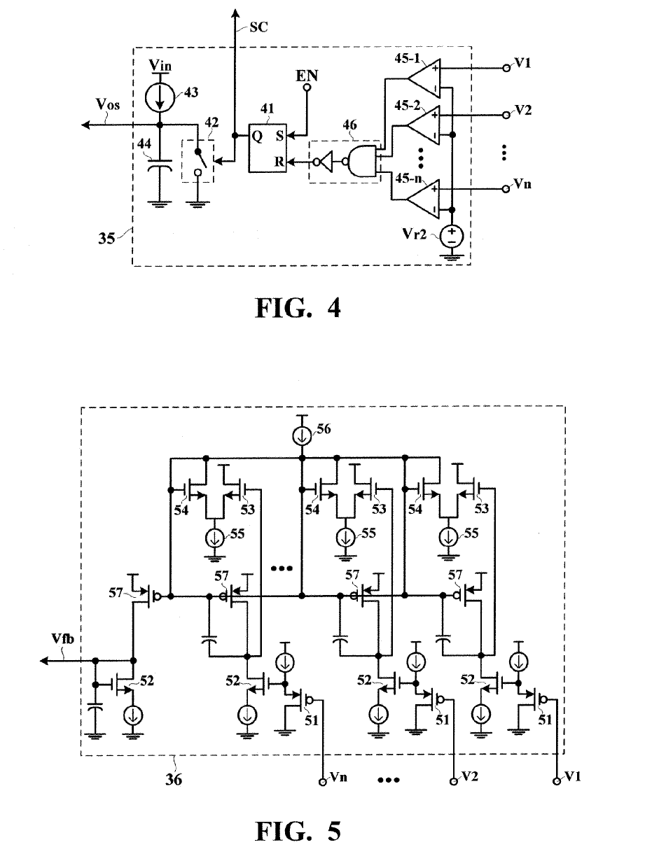

FIG. 4 is a detailed circuit diagram showing the over-voltage activation circuit 35 according to the first embodiment of the present invention. After the drive circuit 30 is powered on, an enable signal EN rises to a high level for setting a latch 41. The enable signal EN may be generated in response to the input voltage source Vᵢₙ from a power-on reset circuit (not shown) whose configuration and operation are well-known to one skilled in the art. The switching control signal SC from the latch 41 turns off a switch 42, thereby allowing a current source 43 to charge a capacitor 44. As a result, the potential difference across the capacitor 44 gradually increases and serves as the activation control signal Vₒₛ. Meanwhile, the switching control signal SC also makes the switching circuit 37 of FIG. 3 coupled to allow the activation control signal Vₒₛ to be applied to the voltage regulator 32. In response to the activation control signal Vₒₛ, the voltage regulator 32 continuously raises the drive voltage Vₒᵤₜ, eventually turning on all of the constituting branches D₁ to Dₙ, and the current regulating terminal voltages V₁ to Vₙ are also increasing. Comparators 45-1 to 45-n are used for determining whether or not each of the current regulator terminal voltages V₁ to Vₙ exceeds the second reference voltage Vᵣ₂. Once all of the current regulating terminal voltages V₁ to Vₙ exceed the second reference voltage Vᵣ₂, the logic circuit 46 outputs a high level to reset the latch 41. More specifically, the logic circuit 46 is formed by an NAND logic gate and an inverter, for performing a logic AND operation against the comparison results of the comparators 45-1 to 45-n. In response to the resetting of the latch 41, the switching control signal SC, on one hand, makes the switch 42 short-circuited to discharge the capacitor 44, and on the other hand makes the switching circuit 37 coupled to allow the error signal Vₑᵣᵣ to be applied to the voltage regulator 32.

FIG. 5 is a detailed circuit diagram showing the feedback selection circuit 36 according to the first embodiment of the present invention. First of all, the current regulating terminal voltages V₁ to Vₙ are raised up by level-shifting transistors 51 to a level that is easier to be processed for subsequent procedures. Transistors 52 function like an inverter, so the minimum signal of the current regulating terminal voltages V₁ to Vₙ are transformed into the maximum signal via the transistors 52. Such inverted signals are applied to gate electrodes of transistors 53. Transistors 53 and 54 together with current sources 55 form differential amplifying pairs. Also, if each of the current sources 55 is designed to have a magnitude of I, the current source 56 should be designed to have a magnitude of (n−0.5)*I. Upon reaching a stable status of operation, the voltage at the gate electrodes of the transistors 54 is substantially equal to the maximum voltage of the inverted signals from the transistors 52. Therefore through an output stage transistor 57, the feedback selection circuit 36 effectively outputs the minimum voltage from the current regulating terminal voltages V₁ to Vₙ to serve as the feedback control signal V_{fb}.

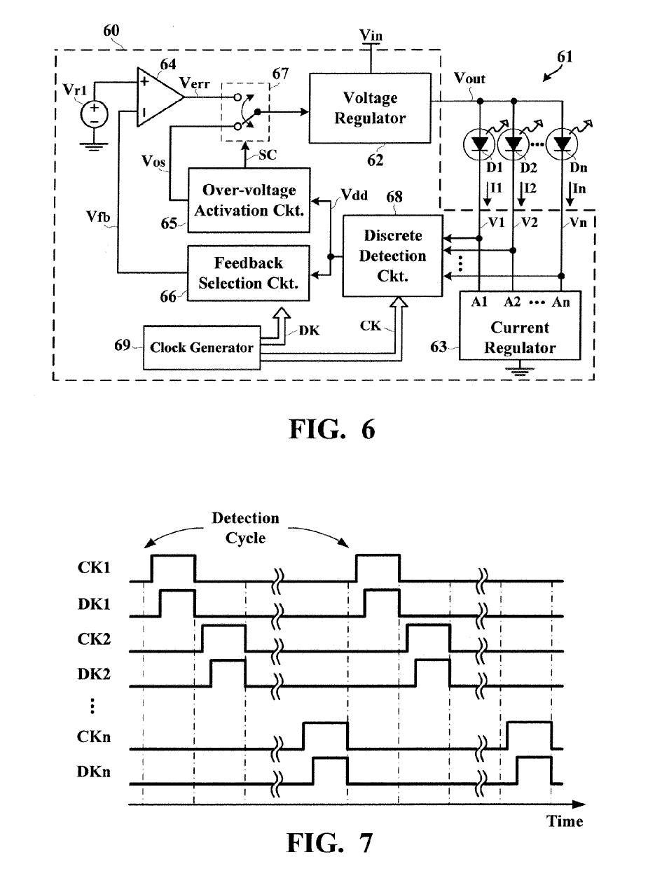

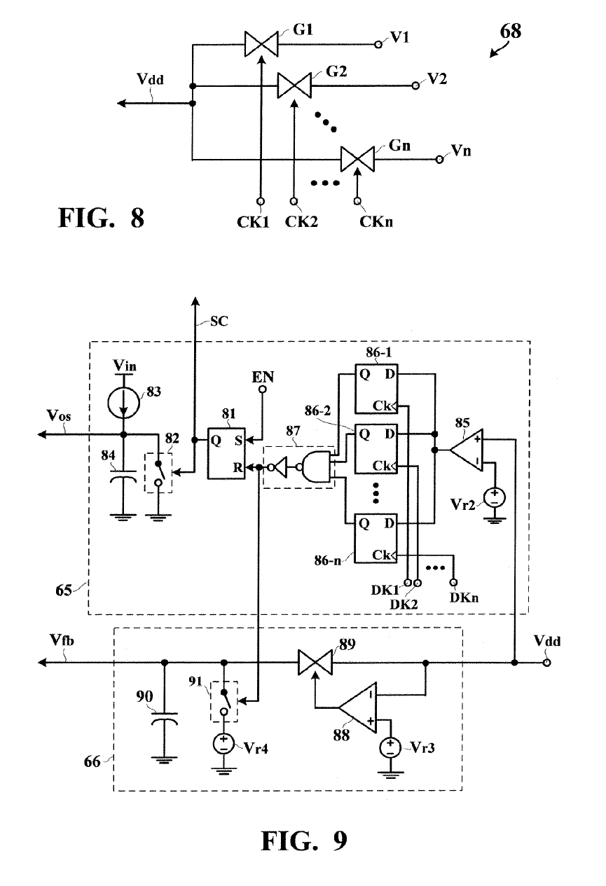

FIG. 6 is a circuit block diagram showing a drive circuit 60 according to a second embodiment of the present invention. The second embodiment is different from the first embodiment in that the drive circuit 60 of the second embodiment further utilizes a discrete detection circuit 68 and a clock generator 69 to detect the current regulator terminal voltages V₁ to Vₙ, one voltage at a time, in accordance with a predetermined sequence. As shown in FIG. 7, clock signals CK₁ to CKₙ from the clock generator 69 trigger the discrete detection circuit 68 in a predetermined sequence, so as to detect the current regulating terminal voltages V₁ to Vₙ, one voltage at a time. As shown in FIG. 8, the discrete detection circuit 68 may be formed by a plurality of transmission gates G₁ to Gₙ, correspondingly coupled to the current regulating terminals A₁ to Aₙ. The clock signals CK₁ to CKₙ are non-overlapping signals with respect to each other. The transmission gates G₁ to Gₙ are turned on by the high level of the clock signals CK₁ to CKₙ, to allow the correspondingly coupled one of the current regulating terminal voltages V₁ to Vₙ to serve as the discrete detection signal V_{dd}.

The drive circuit 60 of the second embodiment also operates through the over-voltage activation phase and the feedback selection phase. As shown in FIG. 9, the enable signal EN transitions to the high level for setting a latch 81 after the drive circuit 60 is powered on. The switching control signal SC generated from the latch 81 makes a switch 82 open-circuited, thereby allowing a current source 83 to charge a capacitor 84. As a result, the potential difference across the capacitor 84 is gradually increasing and serves as the activation control signal Vₒₛ. Meanwhile, the switching control signal SC also makes the switching circuit 67 of FIG. 6 coupled to allow the activation control signal Vₒₛ to be applied to the voltage regulator 62. In response to the activation control signal Vₒₛ, the voltage regulator 62 continuously raises up the drive voltage Vₒᵤₜ, eventually making each of the constituting branches D₁ to Dₙ conductive, and the current regulating terminal voltages V₁ to Vₙ are continuously increasing. Comparator 85 is used for determining whether or not the discrete detection signal V_{dd} exceeds the second reference voltage Vᵣ₂. Upon being triggered by delayed clock signals DK₁ to DKₙ from the clock generator 69, D-type flip-flops 86-1 to 86-n record the comparison results of the comparator 85. The delayed clock signals DK₁ to DKₙ are formed by delaying the clock signals CK₁ to CKₙ with a short period of time, as shown in FIG. 7. During each detection cycle, all of the comparison results recorded in the D-type flip-flops 86-1 to 86-n become the high level as soon as all of the current regulating terminal voltages V₁ to Vₙ exceed the second reference voltage Vᵣ₂. Under such condition, a logic circuit 87 outputs a high level signal to reset the latch 81. More specifically, the logic circuit 87 is formed by an NAND logic gate and an inverter, for performing a logic AND operation against the records stored in the D-type flip-flops 86-1 to 86-n. In response to the resetting of the latch 81, the switching control signal SC, on one hand, makes the switch 82 short-circuited to discharge the capacitor 84, and on the other hand makes the switching circuit 67 coupled to allow the error signal Vₑᵣᵣ to be applied to the voltage regulator 62. Therefore, the voltage regulator 62 is put under the control of the error amplifier 64 and the feedback selection circuit 66. In the feedback selection circuit 66, a comparator 88 has an inverting terminal (−) for receiving the discrete detection signal V_{dd}. The discrete detection signal V_{dd} is allowed to pass through a transmission gate 89 and to serve as the feedback control signal V_{fb} only when the discrete detection signal V_{dd} becomes lower than a third reference voltage Vᵣ₃. Although the transmission gate 89 is nonconductive when the discrete detection signal V_{dd} is higher than the third reference voltage Vᵣ₃, the previously allowed-to-pass discrete detection signal V_{dd} is still held across a capacitor 90. Therefore, the feedback selection circuit 66 effectively selects the minimum voltage from all of the current regulating terminal voltages V₁ to Vₙ to serve as the feedback control signal V_{fb}.

Moreover, the feedback selection circuit 66 may be further equipped with a switch 91 and a fourth reference voltage Vᵣ₄. The switch 91 is controlled by the output signal of the logic circuit 87. During each detection cycle, the output signal of the logic circuit 87 makes the switch 91 short-circuited to allow the fourth reference voltage Vᵣ₄ to serve as the feedback control signal V_{fb} as soon as all of the current regulating terminal voltages V₁ to Vₙ exceed the second reference voltage Vᵣ₂. It should be noted that in the second embodiment, the first to fourth reference voltages Vᵣ₁ to Vᵣ₄ satisfy the following relationship: Vᵣ₁≦Vᵣ₃≦Vᵣ₂≦Vᵣ₄. In one preferred embodiment, the first to fourth reference voltages Vᵣ₁ to Vᵣ₄ are designed to satisfy the following relationship: Vᵣ₁=Vᵣ₃<Vᵣ₂<Vᵣ₄, in which a larger fourth reference voltage Vᵣ₄ may produce a faster rate in decreasing the drive voltage Vₒᵤₜ whenever overshooting happens.

While the invention has been described by way of examples and in terms of preferred embodiments, it is to be understood that the invention is not limited to the disclosed embodiments. To the contrary, it is intended to cover various modifications. Therefore, the scope of the appended claims should be accorded the broadest interpretation so as to encompass all such modifications.

What is claimed is:

1. A drive circuit for driving a light emitting diode array formed by a plurality of constituting branches, comprising:
a voltage regulator for supplying a drive voltage to the light emitting diode array;
a current regulator having a plurality of current regulating terminals, correspondingly coupled to the plurality of constituting branches, for respectively controlling a plurality of drive currents flowing though the plurality of constituting branches;
an activation circuit for applying an activation control signal to the voltage regulator such that the drive voltage is being raised until each of voltages at the plurality of current regulating terminals exceeds a first reference voltage, thereby ensuring that each of the plurality of drive currents reaches a predetermined regulation current; and
a selection circuit, after each of the voltages at the plurality of current regulating terminals exceeds the first reference voltage, for selecting a minimum voltage from the voltages at the plurality of current regulating terminals to serve as a feedback control signal for controlling the voltage regulator.

2. The circuit according to claim 1, further comprising:
an error amplifier for generating an error signal based on a difference between the feedback control signal and a second reference voltage so as to control the voltage regulator, and
a switching circuit for selectively allowing the activation control signal or the error signal to be applied to the voltage regulator.

3. The circuit according to claim 2, wherein:
the second reference voltage is lower than or equal to the first reference voltage.

4. The circuit according to claim 1, further comprising:
a detection circuit, coupled between the plurality of current regulating terminals and the selection circuit, for detecting the voltages at the plurality of current regulating terminals, one voltage at a time, and for outputting a detection signal to the selection circuit.

5. The circuit according to claim 4, further comprising:
a clock generator for generating a clock signal such that the detection circuit detects the voltages at the plurality of current regulating terminals, one voltage at a time, in accordance with the clock signal.

6. The circuit according to claim 5, wherein:
the detection circuit has a plurality of transmission gates, correspondingly coupled to the plurality of current regulating terminals, under a control of the clock signal such that the voltages at the plurality of current regulating terminals are applied to the selection circuit, one voltage at a time.

7. The circuit according to claim 4, wherein:
the selection circuit compares the detection signal and a third reference voltage, and allows the detection signal to be output as the feedback control signal when the selection signal is lower than the third reference voltage.

8. The circuit according to claim 7, wherein:
the third reference voltage is lower than or equal to the first reference voltage.

9. The circuit according to claim 1, wherein:
the activation control signal is a gradually rising voltage.

10. A drive circuit for driving a light emitting diode array formed by a plurality of constituting branches, comprising:
a voltage regulator for supplying a drive voltage to the light emitting diode array;
a current regulator having a plurality of current regulating terminals, correspondingly coupled to the plurality of constituting branches, for respectively controlling a plurality of drive currents flowing through the plurality of constituting branches;
an activation circuit for applying an activation control signal to the voltage regulator such that the drive voltage is being raised until each of voltages at the plurality of current regulating terminals exceeds a first reference voltage;
a detection circuit for detecting the voltages at the plurality of current regulating terminals, one voltage at a time, and for generating a detection signal; and
a selection circuit for comparing the detection signal and a second reference voltage, and for allowing the detection signal to be output as a feedback control signal for controlling the voltage regulator when the detection signal is lower than the second reference voltage.

11. The circuit according to claim 10, wherein:
the second reference voltage is lower than or equal to the first reference voltage.

12. The circuit according to claim 10, further comprising:
an error amplifier for generating an error signal based on a difference between the feedback control signal and a third reference voltage so as to control the voltage regulator, and
a switching circuit for selectively allowing the activation control signal or the error signal to be applied to the voltage regulator.

13. The circuit according to claim 12, wherein:
the third reference voltage is lower than or equal to the first reference voltage, and
the third reference voltage is lower than or equal to the second reference voltage.

14. The circuit according to claim 10, wherein:
the activation control signal is a gradually rising voltage.

15. A drive method for driving a plurality of light emitting diode branches, each of which has a first electrode and a second electrode, comprising:
supplying a drive voltage to the first electrodes of the plurality of light emitting diode branches;
controlling a plurality of drive currents to flow through the plurality of light emitting diode branches, respectively by the second electrodes of the plurality of light emitting diode branches;
raising the drive voltage until each of voltages at the second electrodes of the plurality of light emitting diode branches exceeds a first reference voltage, thereby ensuring that each of the plurality of drive currents flowing through the plurality of light emitting diode branches reaches a predetermined regulation current;
selecting a minimum voltage from the voltages at the second electrodes of the plurality of light emitting diode branches to serve as a feedback control signal; and
controlling the drive voltage based on the feedback control signal.

16. The method according to claim 15, further comprising:
detecting the voltages at the second electrodes of the plurality of light emitting diode branches, one voltage at a time.

17. The method according to claim 15, wherein:
the step of controlling the drive voltage based on the feedback control signal is implemented by generating an error signal based on a difference between the feedback control signal and a second reference voltage so as to control the drive voltage.

18. The method according to claim 17, wherein:
the second reference voltage is lower than or equal to the first reference voltage.
